(19) United States
(12) Patent Application Publication
(10) Pub. No.: US 2022/0363189 A1
(43) Pub. Date: Nov. 17, 2022

(54) ROLLER BLIND SIDE SLIDING RAIL DEVICE OF STRIP LAMP

(71) Applicant: Foshan Baitai Auto Accessories Co., Ltd, Foshan (CN)

(72) Inventor: Yong Xia, Foshan (CN)

(21) Appl. No.: 17/878,097

(22) Filed: Aug. 1, 2022

(30) Foreign Application Priority Data
Apr. 13, 2022 (CN) 202210389571.3

(51) Int. Cl. B60Q 3/53

(52) U.S. Cl. CPC B60Q 3/53; B60Q 2500/00

(57) ABSTRACT

The present disclosure discloses a roller blind side sliding rail device of a strip lamp, the roller blind side sliding rail device of the strip lamp of the present disclosure cooperates with a new material lampshade after an irradiation direction of an LED lamp is deflected, thus achieving better light transmission, and light is clearly visible from a distance.

### TECHNICAL FIELD

The present disclosure relates to a roller blind side sliding rail device of a strip lamp, and belongs to the technical field of roller blind side sliding rail devices of strip lamps.

### BACKGROUND

A roller blind light emitting diode (LED) lamp is one of automobile parts, which is generally installed in a roller blind of an automobile to provide lighting for a driver.

At present, for a commercially available roller blind LED lamp side pole, light of an LED lamp strip is transmitted via a fiber round bar, which causes the problems that the transmitted light is not bright and that the light is weak when it is seen from a distance. Upper and lower parts of an aluminum profile of the side pole are connected only by one position in the middle; the intensity of the upper part is not enough to add other accessories; and furthermore, an opening in the right side is easy to deform, which affects the smooth operation of a roller blind.

### SUMMARY

In order to solve the technical problems in the prior art, the present disclosure provides a roller blind side sliding rail device of a strip lamp with inclined light and lower potential safety hazard.

A technical solution of the present disclosure for solving the technical problems is a roller blind side sliding rail device of a strip lamp, including an LED lamp panel and a fixing component used for fixing the LED lamp panel, and including: a side pole, a lamp strip mounting member, and a bottom plate. The side pole and the lamp strip mounting member form a roller blind side sliding rail device of a strip lamp together with the bottom plate after being connected in parallel.

A recessed functional groove is formed in the side pole in a direction opposite to the lamp strip mounting member; a top of the functional groove is provided with an inside adhesive tape insertion slot facing to the interior of the functional groove and used for mounting an inside adhesive tape 406, and a bottom is provided with a drainage slot facing to the interior of the functional groove.

The lamp strip mounting member is connected to the side pole through a rib; on the basis that the rib is provided with a chamber in a direction opposite to a routing slot of the side pole, a first connecting slot for fastening is formed in the routing slot; an upward accessory fixing slot and a downward accessory fixing slot are convexly arranged upwardly and downwardly on the basis of the routing slot; a lamp strip mounting cavity is provided on outer side walls of the routing slot and the upward accessory fixing slot in a direction opposite to the side pole; and the lamp strip mounting cavity is provided with a lampshade mounting snap-in opening in a manner of being inclined towards the outer side walls of the routing slot and the upward accessory fixing slot.

Optionally, a bottom of the lamp strip mounting cavity is provided with an inclined lamp strip insert mounting slot with an inclined step; a lamp strip insert is a U-shaped slot; a lamp strip is mounted at a slot bottom of the lamp strip insert; a lamp strip insert snap-in protrusion which faces to the interior of the lamp strip mounting cavity is arranged at a position, corresponding to a U-shaped notch of the lamp strip insert, on the inclined lamp strip insert mounting slot and is used for limiting the lamp strip insert.

Optionally, the opening of the lamp strip mounting cavity is provided with a lampshade snap-in opening; the snap-in opening of a lampshade is inclined, and the snap-in protrusion is snapped into a step snap-in opening of a lampshade; an upwards step snap-in protrusion of the lampshade snap-in opening is snapped into a grooved snap-in opening of the lampshade; and the lampshade is inserted and is slantways snapped into the lampshade snap-in opening according to a preset angle.

Optionally, an inclination angle between the lampshade and the rib of the lamp strip mounting cavity ranges from 0 degree to 90 degrees.

Optionally, the inclination angle between the lampshade and the rib of the lamp strip mounting cavity is 30 degrees.

Optionally, a tail end of the roller blind side sliding rail device of the strip lamp is provided with a button switch mounting hole; and after a button switch is mounted, the button switch is routed and connected to the routing slot, and is then connected to a controller on a roller blind box body, so as to control a roller blind to be opened and closed.

It can be known from the above technical solution: (1) Compared with an existing manner, the roller blind side sliding rail device of the strip lamp achieves better light transmission after an irradiation direction of an LED lamp is deflected, and light is clearly visible from a distance.

Compared with the existing manner, the roller blind side sliding rail device of the strip lamp has the advantages that an original insertion slot is eliminated; after the rib for the upper and lower parts is added, the connection strength of the upper and lower parts is higher, and it is safer to add an accessory to the upper part. Furthermore, an opening on the right side of the aluminum profile is difficult to deform, which will not affect the smooth operation of the roller blind. The LED lamp panel and a roller blind box body are slantways mounted, so that lighting for a compartment is guaranteed, and the light is prevented from being directly irradiated to eyes of a driver to cause discomfort, thus avoiding the potential safety hazard.

Compared with the existing manner, the roller blind side sliding rail device of the strip lamp has the advantages that a lamp panel in a roller blind LED lamp is routed in a groove and a routing hole of the groove, so that it is convenient to mount, repair, and remove lines, and this LED lamp is also beautiful and elegant.

Compared with the existing manner, the roller blind side sliding rail device of the strip lamp has the advantages that the button switch is added at the tail end of the side pole, so that the button switch can be used to control the roller blind to be spread and rolled up without using a remote key; and the roller blind LED lamp has a simple structure and small volume.

Compared with the existing manner, the roller blind side sliding rail device of the strip lamp has the advantages that a bottom surface of the fixing component in the roller blind LED lamp is in contact with an aluminum part of the side pole in a large area, which effectively conducts heat generated during use of the light, and the service life of a product is prolonged.

### BRIEF DESCRIPTION OF THE DRAWINGS

FIG. 1 is a schematic structural diagram of an existing electric roller blind side pole strip lamp;

FIG. 2 is a schematic structural diagram of a roller blind side sliding rail device of a strip lamp provided by the present disclosure;

FIG. 3 is a schematic structural diagram of a main body of a roller blind side sliding rail device of a strip lamp provided by the present disclosure;

FIG. 4 is a schematic three-dimensional structural diagram of a roller blind side sliding rail device of a strip lamp provided by the present disclosure;

FIG. 5 is a schematic diagram of a mounting structure of a button switch of a roller blind side sliding rail device of a strip lamp provided by the present disclosure;

FIG. 6 is a schematic diagram of a cross-sectional structure of a roller bind provided with a roller blind side sliding rail device of a strip lamp provided by the present disclosure;

FIG. 7 is a schematic structural diagram of a top view of a roller blind side sliding rail device of a strip lamp provided in a roller bind, provided by the present disclosure;

FIG. 8 is a schematic structural diagram of a button switch in a roller blind side sliding rail device of a strip lamp provided by the present disclosure.

### DETAILED DESCRIPTION OF THE EMBODIMENTS

The present disclosure is specifically described in detail below in combination with the accompanying drawings and embodiments, and the content of the present disclosure is not limited to the following embodiment.

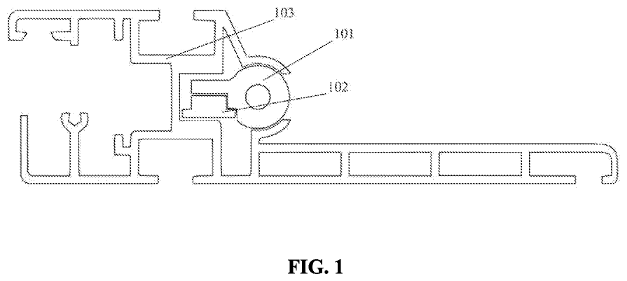

An existing electric roller blind side pole strip lamp in the prior art is illustrated in FIG. 1, light of an LED lamp strip 102 is transmitted via a round bar 101, which causes the problems that the transmitted light is not bright and that the light is weak when it is seen from a distance. Upper and lower parts of an aluminum profile of the side pole are connected only by one position in the middle; the intensity is not enough to add other accessories to an insertion slot 103 and the upper part; and furthermore, an opening in the right side is easy to deform, which affects the smooth operation of a roller blind.

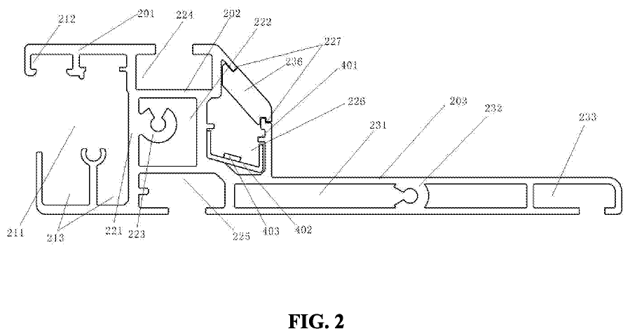

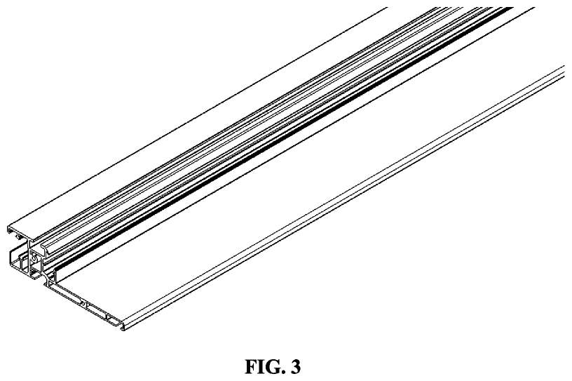

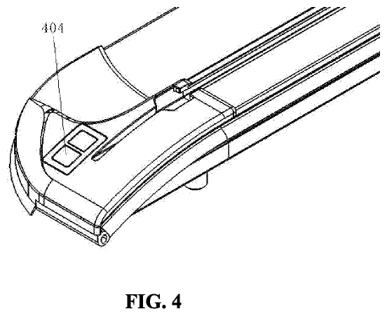

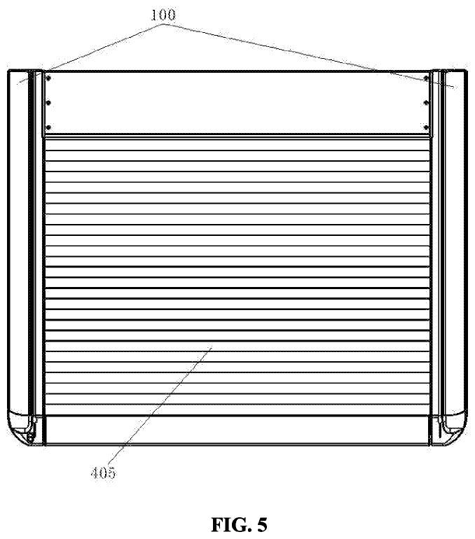

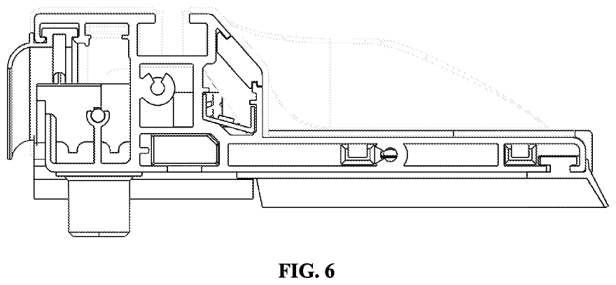

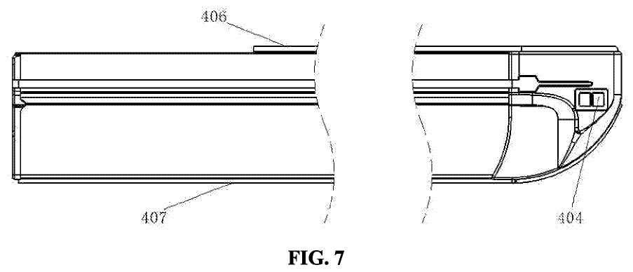

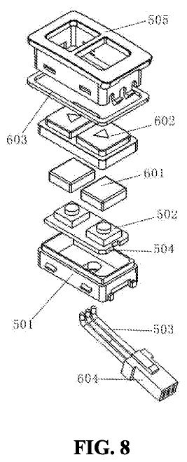

Referring to FIG. 2 to FIG. 8, FIG. 2 is a schematic structural diagram of a roller blind side sliding rail device 100 of a strip lamp provided by this embodiment; FIG. 3 is a schematic structural diagram of a main body of a roller blind side sliding rail device of a strip lamp provided by this embodiment; FIG. 4 is a schematic diagram of a mounting structure of a button switch of a roller blind side sliding rail device of a strip lamp provided by this embodiment; FIG. 5 is a schematic diagram of an overall structure of a roller blind provided with the roller blind side sliding rail device of a strip lamp provided by this embodiment; FIG. 6 is a schematic diagram of a cross-sectional structure of a roller blind provided with a roller blind side sliding rail device of a strip lamp provided by this embodiment; FIG. 7 is a schematic diagram of a top view of a roller blind provided with a roller blind side sliding rail device of a strip lamp provided by this embodiment; and FIG. 8 is a schematic structural diagram of a button switch in a roller blind side sliding rail device of a strip lamp provided by this embodiment. Compared with the prior art, this embodiment has the advantages that the roller blind side sliding rail device of a strip lamp cooperates with a new material lampshade after an irradiation direction of an LED lamp is deflected, thus achieving better light transmission, and light is clearly visible from a distance. An original insertion slot is eliminated; after a rib for the upper and lower parts is added, the connection strength of the upper and lower parts is higher, and it is safer to add an accessory to the upper part. Furthermore, an opening on the right side of the aluminum profile is difficult to deform, which will not affect the smooth operation of the roller blind. A button switch is added at a tail end of a left side pole, so that the button switch can be used to control a roller blind to be spread and rolled up without using a remote key.

Specifically, this embodiment provides a roller blind side sliding rail device of a strip lamp, including an LED lamp panel and a fixing component used for fixing the LED lamp panel, and including: aside pole 201, a lamp strip mounting member 202, and a bottom plate 203. The side pole and the lamp strip mounting member form the roller blind side sliding rail device of the strip lamp together with the bottom plate after being connected in parallel.

A recessed functional groove 211 is formed in the side pole 201 in a direction opposite to the lamp strip mounting member; a top of the functional groove is provided with an inside adhesive tape insertion slot 212 facing to the interior of the functional groove, and a bottom is provided with a drainage slot 213 facing to the interior of the functional groove.

The lamp strip mounting member 202 is connected to the side pole 201 through a rib 221; on the basis that the rib is provided with a chamber 222 in a direction opposite to a routing slot of the side pole, a first connecting slot 223 for fastening is formed in the routing slot; an upward accessory fixing slot 224 and a downward accessory fixing slot 225 are convexly arranged upwardly and downwardly on the basis of the routing slot; a lamp strip mounting cavity 226 is provided on outer side walls of the routing slot and the upward accessory fixing slot in a direction opposite to the outside pole; the lamp strip mounting cavity is provided with a lampshade mounting snap-in opening 227 in a manner of being inclined towards the outer side walls of the routing slot and the upward accessory fixing slot.

The bottom plate 203 extends along an extending direction of the downward accessory fixing slot that is perpendicular to the rib and is located below the lamp strip mounting cavity; the bottom plate is hollowed to form a fixing chamber 231 for mounting a connector; a second connecting slot 232 for fastening is formed in the fixing chamber; and a downward outside adhesive tape insertion slot 233 is provided in an outer side of the fixing chamber and is used for mounting an outside adhesive tape 407.

In some optional embodiments, a bottom of the lamp strip mounting cavity is provided with an inclined lamp strip insert mounting slot with an inclined step; a lamp strip insert is a U-shaped slot 402; a lamp strip 403 is mounted at a slot bottom of the lamp strip insert; a lamp strip insert snap-in protrusion which faces to the interior of the lamp strip mounting cavity is arranged at a position, corresponding to a U-shaped notch of the lamp strip insert, on the inclined lamp strip insert mounting slot and is used for limiting the lamp strip insert.

In some optional embodiments, the opening of the lamp strip mounting cavity is provided with a lampshade snap-in opening; the snap-in opening of a lampshade 236 is inclined, and the snap-in protrusion is snapped into a step snap-in opening of the lampshade; an upwards step snap-in protrusion of the lampshade snap-in opening is snapped into a grooved snap-in opening of the lampshade; and the lampshade is inserted and is slantways snapped into the lampshade snap-in opening according to a preset angle.

In some optional embodiments, an inclination angle between the lampshade and the rib of the lamp strip mounting cavity ranges from 15 degrees to 85 degrees. Preferably, the inclination angle between the lampshade and the rib of the lamp strip mounting cavity is 30 degrees.

In some optional embodiments, the downward accessory fixing slot is a mounting and fixing slot for a roller blind 405; and a side wall of the mounting and fixing slot for a roller blind is provided with a convex body which protrudes into the mounting and fixing slot for a roller blind and is used for limiting the roller blind.

In some optional embodiments, a tail end of the roller blind side sliding rail device of the strip lamp is provided with a button switch mounting hole; and after a button switch 404 is mounted, the button switch is routed and connected to a controller on the roller blind box body, so as to control the roller blind to be opened and closed.

In some optional embodiments, wall thicknesses of all parts of the roller blind side sliding rail device of the strip lamp are consistent. The roller blind side sliding rail device of the strip lamp is prepared from an aluminum alloy profile.

In some optional embodiments, a button switch (i.e., the button switch 404) of the roller blind side sliding rail device of the strip lamp includes a side pole switch shell 501, a micro switch 502, a switch power line 503, a switch circuit board 504, and a switch cover 505.

The side pole switch shell is a shell in which a switch mounting cavity is recessed, and an outer wall is provided with a fastener accessory which is mounted to the mounting slot on the roller blind side sliding rail device of the strip lamp.

The switch circuit board is mounted at an inner bottom of the switch mounting cavity.

The micro switch is mounted in the switch mounting cavity, and a control button of the switch is located at an upper part of the switch circuit board.

The switch cover is covered on the switch mounting cavity through cooperation between a buckle on an outer wall and a snap-in structure on an inner wall of the switch mounting cavity, so as to cover a functional component of the switch into the switch mounting cavity.

The switch power line penetrates through the side pole switch shell, with one end connected to the switch circuit board and the other end located outside the switch shell.

In some optional embodiments, the micro switch is provided with a micro switch button cap 601 which is buckled on and wraps the micro switch.

In some optional embodiments, a switch soft rubber cover 602 is arranged on an outer side of the micro switch button cap, and is buckled on and wraps the micro switch button cap.

In some optional embodiments, a waterproof rubber pad 603 is arranged between the side pole switch shell and the mounting slot on the roller blind side sliding rail device of the strip lamp.

In some optional embodiments, an end socket of the switch power line that is located outside the switch shell is provided with a wiring connector clip 604.

In some optional embodiments, the bottom surface is in contact with a roller blind box body in a large area, which effectively conducts heat generated during use of light, so that the product is protected from being damaged by overheat during use, and the service life of the product is prolonged.

The above descriptions are only the specific implementations of the present disclosure, and changes that are easily thought by those skilled in the art within the scope disclosed by the present disclosure shall fall within the protection scope of the present disclosure.

1. A roller blind side sliding rail device of a strip lamp, comprising a light emitting diode (LED) lamp panel and a fixing component used for fixing the LED lamp panel, and comprising: aside pole, a lamp strip mounting member (which has the serial number of 1 and is used for mounting a base of a lamp strip), and a bottom plate, wherein the side pole and the lamp strip mounting member form a roller blind side sliding rail device of the strip lamp together with the bottom plate after being connected in parallel;
a recessed functional groove is formed in the side pole in a direction opposite to the lamp strip mounting member; a top of the functional groove is provided with an inside adhesive tape insertion slot facing to the interior of the functional groove, and a bottom is provided with a drainage slot facing to the interior of the functional groove;
the lamp strip mounting member is connected to the side pole through a rib; on the basis that the rib is provided with a chamber in a direction opposite to a routing slot of the outside pole, a first connecting slot for fastening is formed in the routing slot; an upward accessory fixing slot and a downward accessory fixing slot are convexly arranged upwardly and downwardly on the basis of the routing slot; a lamp strip and a mounting cavity for fixing the whole lamp strip are provided on outer side walls of the routing slot and the upward accessory fixing slot in a direction opposite to the side pole; the lamp strip mounting cavity is provided with a lampshade mounting snap-in opening in a manner of being inclined towards the outer side walls of the routing slot and the upward accessory fixing slot.

2. The roller blind side sliding rail device of the strip lamp according to claim 1, wherein a bottom of the lamp strip mounting cavity is provided with an inclined lamp strip insert mounting slot with an inclined step; a lamp strip insert is a U-shaped slot; an LED lamp strip is mounted at a slot bottom of the lamp strip insert; a lamp strip insert snap-in protrusion (401 in FIG. 2, used for limiting) which faces to the interior of the lamp strip mounting cavity is arranged at a position, corresponding to a U-shaped notch of the lamp strip insert, on the inclined lamp strip insert mounting slot and is used for limiting a lamp strip insert.

3. The roller blind side sliding rail device of the strip lamp according to claim 2, wherein the opening of the lamp strip mounting cavity is provided with a lampshade snap-in opening; the snap-in opening of a lampshade is inclined, and the snap-in protrusion is snapped into a step snap-in opening of the lampshade; an upwards step snap-in protrusion of the lampshade snap-in opening is snapped into a grooved snap-in opening of the lampshade; and the lampshade is inserted and is slantways snapped into the lampshade snap-in opening according to a preset angle.

4. The roller blind side sliding rail device of the strip lamp according to claim 3, wherein an inclination angle between the lampshade and the rib of the lamp strip mounting cavity ranges from 0 degree to 90 degrees.

5. The roller blind side sliding rail device of the strip lamp according to claim 4, wherein the inclination angle between the lampshade and the rib of the lamp strip mounting cavity is 30 degrees.

6. The roller blind side sliding rail device of the strip lamp according to claim 1, wherein a tail end of the roller blind side sliding rail device of the strip lamp is provided with a button switch mounting hole; and after a button switch is mounted, the button switch is routed and connected to a controller on a roller blind box body, so as to control a roller blind to be opened and closed.
